(19) United States
(12) Patent Application Publication
(10) Pub. No.: US 2021/0319776 A1
(43) Pub. Date: Oct. 14, 2021

(54) DEVICE, SYSTEM, AND METHODS FOR BATTERIES REPLACEMENT IN ELECTRICAL INSTRUMENTS

(71) Applicant: Robert John Williams, Overland, MO (US)

(72) Inventor: Robert John Williams, Overland, MO (US)

(21) Appl. No.: 17/207,896

(22) Filed: Mar. 22, 2021

Related U.S. Application Data
(60) Provisional application No. 62/992,933, filed on Mar. 21, 2020.

(51) Int. Cl. G10H 1/32

(52) U.S. Cl. CPC G10H 1/32

(57) ABSTRACT

The present disclosure relates to a device and system for eliminating and replacing batteries in any instruments with active electronics, preamp, and piezo pickups. The accessory device and systems have a combination of quarter-inch audio and nine-volt power cable and the methods thereof. Both mono and stereo versions of the apparatus and systems are presented herein. The device further has a mock batter that can power other instruments. Battery leakage can cause corrosion in the instrument. Therefore, the device protects the instrument from corrosive harm, and the electrical device reduces the cost associated with battery usage and the operator's business's overall cost.

### CROSS-REFERENCE TO RELATED APPLICATIONS: NONE

This application is a Non-Provisional application claiming priority of the Provisional U.S. Application No. 62/992,933 filed on Mar. 2, 2020, and is incorporated in entirety herein by references.

### STATEMENT REGARDING FEDERALLY SPONSORED RESEARCH OR DEVELOPMENT

Not applicable.

The present disclosure relates to a device and system for replacing or eliminating batteries in any instruments with active electronics, preamp, and piezo pickups.

### BACKGROUND

Several electrical or electronic instruments with active electronics preamp and piezo pickups use batteries. This need for batteries limits usage time during the instrument operation, causing inconvenience to the operator. It also adds to the overall cost of the operator's business. Battery leakage can cause corrosion in the instrument, so it harms the instrument and the electrical device. This invention provides a device and system for eliminating the need for the battery. Hence, it increases usage-time while reducing the cost of operations and replacing eroded instrument parts. This invention will keep the excess waste of batteries out of the landfills.

### BRIEF DESCRIPTION OF THE INVENTION

To eliminate batteries in string instruments, a musical instrument accessory device and systems comprising a combination of quarter-inch audio and nine-volt power cable, and the methods thereof.

This device is an electrical device for musical instruments made-up of a hollow transfer station with an inner chamber. The chamber has one or more one audio signal cable and at least one or more one power cable within the station and may be configured to eliminate batteries.

In an embodiment of the invention, the audio cable may have mono input jacks for the audio signal's output.

In an embodiment of the invention, the mono input jack may be connected to mono-cable, and at the end of the mono cable, and the jack may be attached to the transfer station.

In an embodiment of the invention, the audio cable may have stereo input jacks for the audio signal's output.

In an embodiment of the invention, the stereo input jack may be connected to stereo-cable, and at the end of the stereo cable, and the jack is attached to the transfer station.

In an embodiment of the invention, the audio signal cable may be configured in audio signal processing applications.

In an embodiment of the invention, the power cable(s) total electrical potential may be equivalent to the battery's electrical potential.

In an embodiment of the invention, the power cable may have a total electrical potential of 1 to 22 volts.

In an embodiment of the invention, the transfer station may have two DC power connectors for the AC/DC external supply.

In an embodiment of the invention, the transfer station may have at least a one-quarter-inch or more quarter-inch stereo input jack for the audio signal.

In an embodiment of the invention, the transfer station may have at least a one-quarter-inch or more quarter-inch mono input jack for the audio signal.

In an embodiment of the invention, the transfer station may have a quarter-inch stereo input jack, which may double or also function as the input for the musical instrument signal and the output for a power source.

In an embodiment of the invention, the transfer station may have one or more from a group consisting of XLR, XLR combo jack, eight-inch jacks, phone jacks, TRRS, Tip-Ring-Ring-Sleeve jacks, and any combination thereof.

In an embodiment of the invention, the transfer station may be made of aluminum, and the station dimensions are length 3.94 inches×width 1.97 inches×depth 1.06 inches.

In an embodiment of the invention, the transfer station can power one or more stompboxes.

In an embodiment of the invention, the stompboxes can require a total electrical potential of 1 to 22 volts.

In an embodiment of the invention, the electrical device for musical instruments may have a mock nine-volt battery adapter, wherein the mock battery is placed within the battery cavity of the musical instrument.

In an embodiment of the invention, the mock battery adapter may be made of epoxy or plastic.

In an embodiment of the invention, the mock battery adapter may have a closed connection metal first snap connector, and the first nap connector is connected to the second snap connector of the musical instrument closing the connection allowing the ground on the jack to become the power source from the Transfer Station.

### BRIEF DESCRIPTION OF FIGURES

FIG. 1: Shown herein is the outer Transfer Station with output and input jacks, wires and cables. FIG. 1A shows the mono version, and FIG. 1B shows the stereo version.

FIG. 1C shows possible connections to the input and output jacks on the Transfer Station 100C.

FIG. 1D shows the inside of Transfer Stations.

FIG. 2. Shown herein is a schematic of all the connections and wiring for mono versions, 2A, and stereo versions, 2B.

FIG. 3. Shown herein is a mock battery.

### DETAILED DESCRIPTION OF THE INVENTION

Examples embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps, unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning, definition, or interpretation.

As used herein, the term “Transfer Station” means the outermost covering or encasing that houses various components of the device and systems herein. The inside of the transfer station may have one or more components, and the outside may have one or more components, and one or more components may be both inside and outside.

As used herein, the term “chamber” means hollow space within the outer jacket of the Transfer Station.

As used herein, the term “audio signal processing applications” means any musical instrument, including, but not limited to, string instruments, drums, etc.

As used herein, the term “instrument” means one or more electrical instruments or equipment.

As used herein, the term “electrical” means electrical and/or electronics.

In one embodiment of the invention, batteries may be eliminated from the audio signal processing applications. Without the battery elimination, the playtime may be limited based upon the battery's life-time; this requirement may cause a temporary shutdown, interruption, and inconvenience during both training and concerts and may add to the cost of the concert. The battery use may not be environmentally friendly as the batteries contribute to landfills. The invention herein eliminates such need for batteries; and hence, may remove the inconvenience of battery change during concert and training. This invention, therefore, may contribute to a reduction in battery-associated costs and is eco-friendly. The use of this system and device may not be limited to musical instruments but may be used with any electrical equipment that requires batteries.

In an invention's embodiment, this invention may eliminate the battery's use by attaching it to the battery snap connector in the electrical instrument/equipment and may power it with an alternative power source.

In an embodiment of the invention, the alternative power source may be a tuner pedal with an extra nine-volt connection. It may plug nine-volt snaps the connectors into instrument nine-volt snap connector, and/or any combination thereof.

In an embodiment of the invention, one or more batteries maybe, but not limited to, 1.2V, 1.5V, 3V (LiMnO₂), 3.6V (LiSOCl₂), 3V, 4.5V, 5V, 5.3V, 6V, Alkaline: 6.2V, Silver-oxide: 6.5V, 7.2V, 8V, 9V, 9.6V, etc., and/or any combination thereof.

In an embodiment of the invention, one or more batteries may be combined to yield a total voltage of 1-22 volts, more specifically, nine volts. Each battery maybe 1, 2, 3, 4, 5, 6, 7, 8, 9, 10, 11, 12, 13, 14, 15, 16, 17, 28, 19, 20, and/or 21 volts and/or a fraction thereof. The batteries may be active electronic or preamps.

In an embodiment of the invention, the batteries may be according to the International Electrotechnical Commission, IEC, and National Electrical Manufacturers Association, NEMA, standards, and/or non-standard for portable primary batteries.

In an embodiment of the invention, the battery may be lead-acid, Nickel, lithium, lithium-ion, alkaline, based, and/or any combination thereof.

In an embodiment of the invention, audio signal processing applications maybe musical instruments such as string, non-string instruments, sound effects, Chapman Stick, Clavinet, Console steel guitar, Saxophone, Denis D'or, Electric banjo, Electric bass, Electric cello, Electric guitar, Gittler guitar, Semi-acoustic Guitar, Electric harp, Electric lamellophone, Electric mandolin, Electric piano, Piano Bass, Rhodes piano, Pianet, Electric sitar, Electric upright bass, Electric Viola, Electric violin, Gravikord, Electric Organ, Telharmonium, Hammond organ, Harpejji, Kiboe, Moodswinger, Pedal steel guitar, Tap-board, etc.

In an embodiment of the invention, the system may comprise an out housing jacket referred to herein as “Transfer Station.” Transfer Station box that may be made of a number of non-synthetic or synthetic materials, e.g., die-cast aluminum electronic enclosure, other metal and alloys used in electrical equipment, plastics, a combination polyvinyl chloride (PVC), moldable polymers, acrylics, polyesters, silicones, polyurethanes, and halogenated plastics, thermoplastics and thermosets, conductive polymers, biodegradable plastics and engineering plastics, polyethylene (PE), polypropylene (PP), polystyrene (PS) and polyvinyl chloride (PVC), Polycarbonate (PC), High-density polyethylene (HDPE), Polypropylene (PP), Acrylonitrile butadiene styrene (ABS), Polycarbonate plus Acrylonitrile Butadiene Styrene (PC+A), Phenolics or phenol-formaldehyde (PF), Polyetheretherketone (PEEK), Polysulfone, Polydiketoenamine (PDK), etc. and any combination thereof.

In an embodiment of the invention, battery corrosion-related damage to the instrument may be prevented.

In an embodiment of the invention, the Transfer Station box dimensions may be as follows, but not limited to, length 3.94 inches width 1.97 inches depth 1.06 inches. This device uses two DC power connectors for the AC/DC external power supply. The device may use one or two quarter-inch stereo or mono input jacks for the output of the audio signal. The device may also use a quarter-inch stereo input jack that may double as the input for the instrument signal and the output for the power source

In an embodiment of the invention, the jack sizes may usually be quarter inch but not limited to those. The box may also utilize an XLR or XLR combo jack, eight-inch jacks, phone jacks, TRRS (Tip-Ring-Ring-Sleeve) jacks, etc.

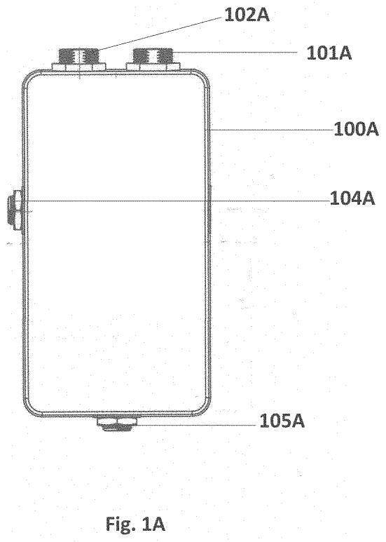

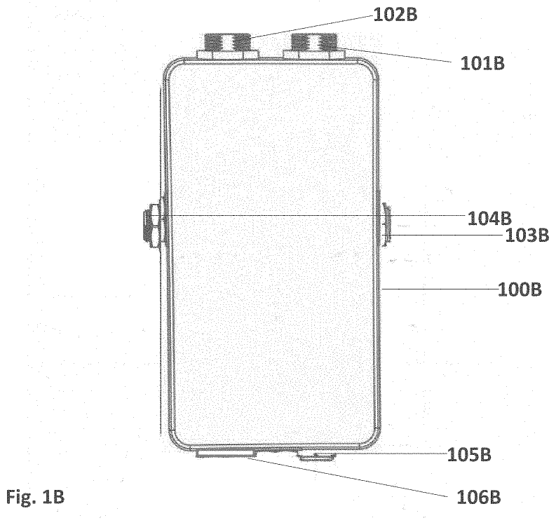

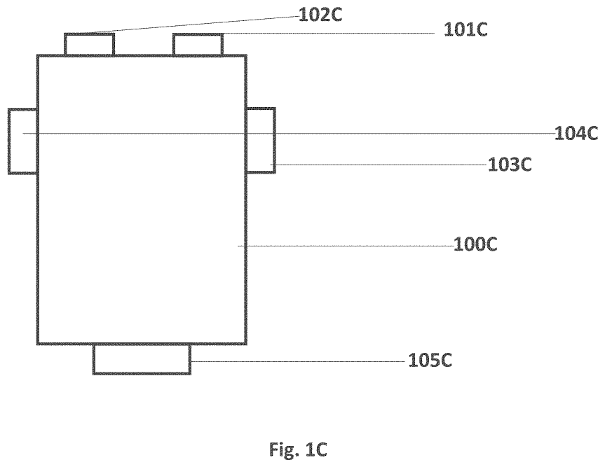

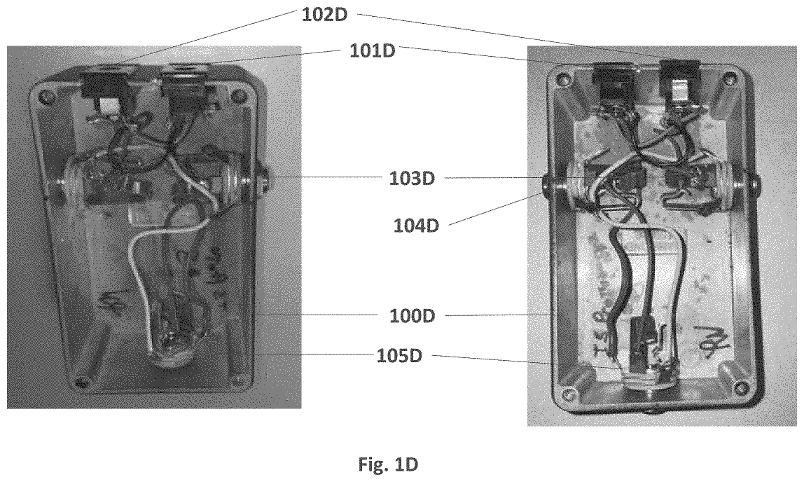

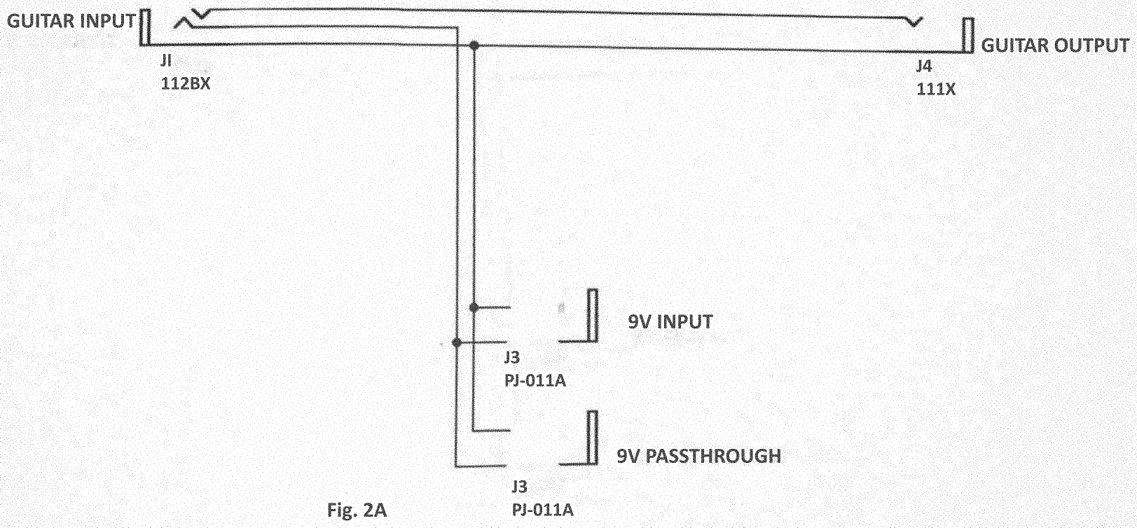

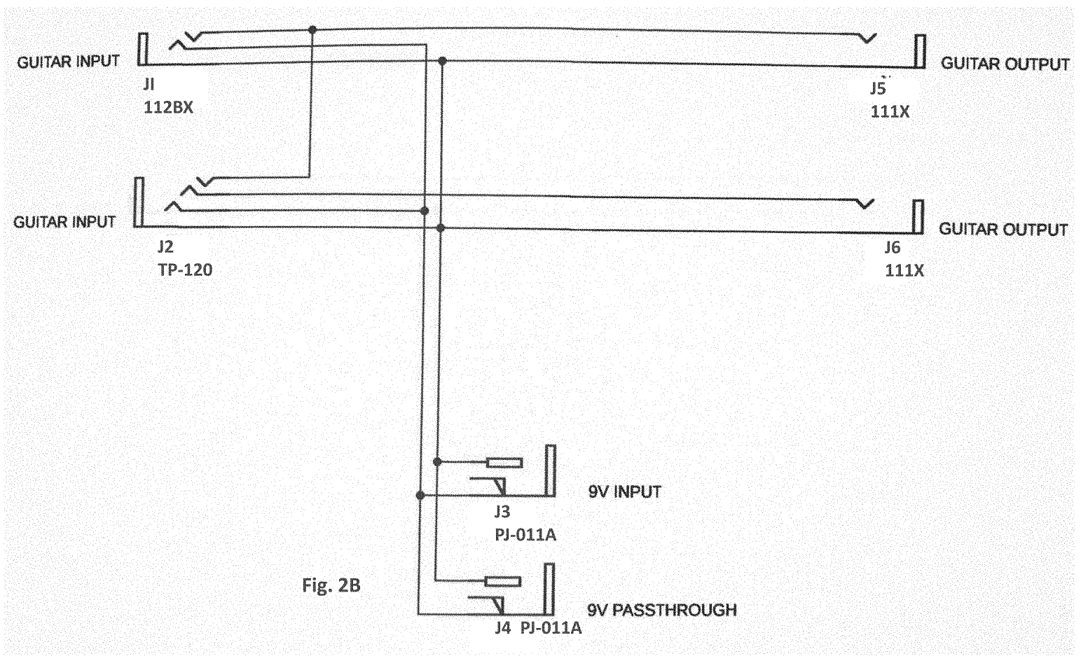

In an embodiment of the invention, the Transfer Station box may be made of an AC/DC power supply that connects to the DC power connector. Electric current may travel through the connected wires and then out through the stereo jack(s), and next may transfer the current travel through the stereo jack(s) to the instrument. It may simultaneously be sending the audio signal from the device back through the instrument cable to the Transfer Station, where the audio signal may be sent out through the mono- or stereo-jacks into a mono- or stereo instrument cable into another stompbox or amplifier as shown in the FIGS. 1 and 2. The extra DC power connector may be utilized to power up another stompbox (effects pedal) or may even receive power from another stompbox.

In an embodiment of the invention, a mock battery made of epoxy or plastic with a closed connection metal snap connector may be connected to the snap connector in the instrument closing the connection allowing the ground on the jack to become the power source from the Transfer Station. The mock battery can be 1.2V, 1.5V, 3V (LiMnO₂), 3.6V (LiSOCl₂), 3V, 4.5V, 5V, 5.3V, 6V, Alkaline: 6.2V, Silver-oxide: 6.5V, 7.2V, 8V, 9V, 9.6V, etc., or any combination thereof.

In an embodiment of the invention, the mock/faux batter may be placed in the instrument's battery cavity. The mock batter may replace the actual battery.

In an embodiment of the invention, 1-22 volt, e.g., 1.5, 4.5, 6, 9, 12 volt AC/DC power supply may be utilized to provide power to the Transfer Station.

In an embodiment of the invention, the mock battery may comprise adapter(s).

In an embodiment of the invention, the device may comprise one or two cables; the first cable may be selected from an instrument cable, XLR, or standard two-conductor microphone cable, high density braided copper shield, and two inner conductors. The first cable may provide for a pathway for the sound waves to travel from the instrument to the amplification or pedal output source with one wire that is dedicated to audio, e.g., the negative wire.

In an embodiment of the invention, the second cable may comprise of three smaller sections of microphone cables for jumping off or being spliced into a larger cable, one at an amp or pedal end, two at instrument end with a connector in the middle of a small microphone cable for the nine-volt power source; the nine-volt may be replaced by 1.5, 4.5, 6, and/or 12 volts. The smaller two cables may provide transferring power from the pedal/stomp or power supply to the instrument preamp or active electronics as the two smaller jump off the first cable supply, one on each end of the first cable, utilizing the unused wire such as the positive wire.

In an embodiment of the invention, the device may further be made of three connectors, a first connection may be a two audio quarter “cable mounts or connectors, mono or stereo for audio, the second connector is a nine-volt snap connector for power supply, and the third connector may be a DC power plug for power supply. The cable XLR and two-pin connectors may be necessary for the proper functioning of the device.

The device may optionally be made of a mini three-pin female and male XLR connector, or some other detaching connector source may be used, such as RCA-connectors or a one, two, three, four, five, six, seven, eight-pin, preferably a two-pin connector.

The device may optionally be made of three cables, the first optional alternative cable source, single nine-volt, wherein the nine-volt may be replaced by 1.5, 4.5, 6, and/or 12 volts. Power cable, the second optional cable, maybe two Y cables: female XLR connector split to a male quarter connector and nine-volt snap connector and male XLR connector to a quarter-inch connector and DC power plug and/or any combination therein, and the third optional cable is a quad cable. The nine volts may be replaced by 1.5, 4.5, 6, and/or 12 volts.

The device optionally may be made of a cable connector or cable clamp.

The three optional cables may stand by themselves as power supply cables from pedal or power source to the instrument preamp or active electronics and may also have the optional cable connectors. The connection between the power cable and the instrument cable may be via an XLR three-wire cable that may be used and adjusted as a combined audio/nine-volt power supply using different electrical adapters at each end.

In an embodiment of the invention, the quarter-inch cable mounts or connectors mono or stereo may be attached at each end of the main cable and plug into receiving quarter-inch jacks at instrument end and amp pedal on opposite the main cable end.

In an embodiment of the invention, the nine-volt snap connector for the power supply may be attached to a microphone cables section. A small connector such as a three-pin mini XLR male and female connector or some other connector source such as a one, two, three, four, five, six, seven, eight-pin, preferably two-pin connector, the cable may be separated or split from the smaller cables. At the instrument end of the cable, the nine-volt snap connector connects to a nine-volt snap connector already installed in the instrument.

In an embodiment of the invention, the DC power plug may be attached to the smaller microphone cable at amp or pedal and on the main cable and plugs into the power supply.

In the invention's embodiment, the mini XLR connectors or other connectors source may be located at the instrument end of small microphone cables dividing them into two sections for easy removal. This arrangement may leave the nine-volt snap connecting sections to the instrument, especially in the case of multiple instruments that the cable may be plugged into it.

In an embodiment of the invention, the system and device may help eliminate the battery(s) by combining the various elements of the device in several different ways. However, a mechanism maybe when the first audio quarter-inch cable may be plugged into the amp and instrument allowing the transfer of audio through the negative wire from the instrument to the amp, while the smaller microphone cable that may be spliced into it may be plugged into the power source and the other smaller microphone cable may be plugged into the nine-volt snap connector in the instrument from the preamp or active electronics of the instrument allowing the transfer of power from the power source through main cable positive wire to opposite spliced small cable, powering the instruments electronic components

In the invention's embodiment, the invention manufacturing may be performed by quarter-inch mono or stereo connectors to the negative wire and shield wire on both ends of the main audio cable. The microphone/instrument cable may be spliced into an audio cable utilizing positive wire and shield wire on both ends to create the separation of power and audio. At one end, the smaller cable, a DC power plugged, may be attached; at the other end of the small cable, the nine-volt snap connector may be attached, and an optional connector may be soldered between the snap connector and splice if so desired.

In another embodiment of the method of manufacturing, the invention may be by different audio or instrument cables that may be used as long as there are three to 4 wires and even other size cables. An XLR cable and XLR connectors may be adapted to be used as well

In an embodiment of the invention, a Y connector system to achieve the same result using a mike cable with XLR's connectors as the go-between cable or with quarter-inch jacks, etc.

As can be appreciated, several types of connectors may be used and interchanged and modifying the instrument jacks and connections.

In an embodiment of the invention, the device may be used by plugging the quarter-inch connections into the instrument and amp or pedal. After that, plug the DC power connection into a power source, such as a tuner pedal with an extra nine-volt connection, plug a nine-volt snap connector into the instrument's nine-volt snap connector, turn on the power and amp.

### Detailed Description of Figures

Below is a detailed description of the figures for one or two embodiments. However, it is to be understood that this description is intended for illustrative purposes and is not limited and restrictive to these examples. Other embodiments of the invention are possible with different instruments and batteries.

FIG. 1: Shown herein is the outer Transfer Station 100 A, B, C, D with output and input jacks. FIG. 1A shows the mono version, and FIG. 1B shows the stereo version. Figures A and B also show the possible dimensions and arrangements of the jacks. FIG. 1B depicts a plug for XLR style jacks 106B. FIG. 1C shows possible connections to the input and output jacks on the Transfer Station 100C. FIG. 1D shows the inside of the Transfer Station. 101A, B, C, D, and 102 A, B, C, D may be boss-style jacks. The external voltage power supply jack may be a 9-volt power jack or outlet power supply source 101 A, B, C, D, but it may be another volt such as 1, 2, 3, 4, 5, 6, 7, 8, 9, 10, 11, 12, 13, 14, 15, 16, 17, 28, 19, 20, 21, and/or 22 volts and/or a fraction thereof. As shown, the current transfer station lacks a stompbox 100 A, B, C, D. However, the invention may provide power to operate other stompbox-style electrical equipment, devices, instruments, etc. The secondary power source may provide power to or input supply inlet to other electrical equipment, appliances, instruments, etc., including other stompbox-style instruments 102 A, B, C, D. The incoming voltage power supply jack may be a 9-volt power jack or outlet power supply source 102 A, B, C, D, but it may be another volt such as 1, 2, 3, 4, 5, 6, 7, 8, 9, 10, 11, 12, 13, 14, 15, 16, 17, 28, 19, 20, 21, and/or 22 volts and/or a fraction thereof. The instrument cable plug jack for signal output may be mono-signal or stereo signal. On the left side in this example, the instrument cable plug jack is mono signal output 104 A, B, C, D; whereas, the instrument cable plug jack for the stereo-signal output, on the right side in this example, for stereo applications 103 B, C, D. It is understood that these jacks' locations may be at other places and maybe of different numbers, such as one, two, three, four, or more within the transfer station. The transfer station also may have one or more input jacks or plugs to receive one or more instrument cable(s) 105 A, B, C, D. The device may use one or two quarter-inch stereo- or mono-signal input jacks for the output of the audio signal. The device may also use a quarter-inch stereo input jack that may double as the input for the instrument signal and the output for the power source. The jack sizes may usually be quarter inch but not limited to those. The box may also utilize an XLR or XLR combo jack, eight-inch jacks, phone jacks, TRRS (Tip-Ring-Ring-Sleeve) jacks, etc. The cable XLR and one, two, three, four, five, six, seven, eight-pin, or more pin connectors, preferably two-pin connectors. FIG. 1D shows an embodiment of the invention's transfer station inside and outside. The hollow chamber or encasing may have one or more jacks, wires, cables, etc. Some of these, such as jacks, are attached to the transfer chamber walls such that part(s) of them may be inside the hollow chamber and part(s) may be outside. Some wires and/or cables might be only within the chamber, while other wires or cables may pass through the walls to the outside. They are both inside and outside the hollow chamber. Some part(s) may be attached to the outside and/or inside the transfer station, such as adaptors; they may be attached to one or more sides of the transfer station's walls. The hollow chamber may have components completely inside, completely outside, on both inside and outside, may be attached to either outside, inside walls, or both walls, and/or may pass through the walls. It is understood that these arrangements shown in the figure may be different for different embodiments of the invention, and only one such arrangement is depicted herein.

FIG. 2. Wiring and connections. Shown herein is a schematic of all the connections and wiring for mono versions, 2A, and stereo versions, 2B.

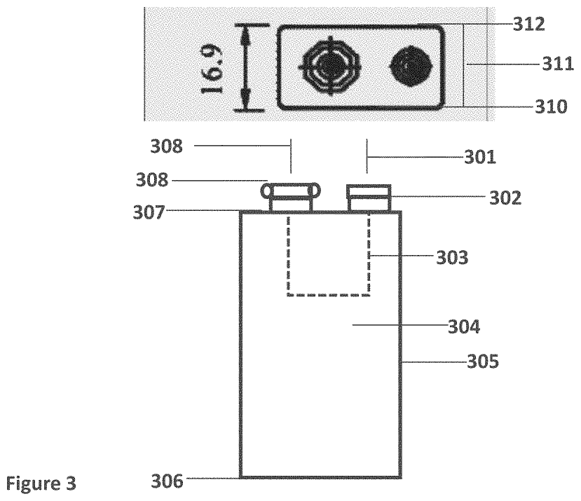

FIG. 3: Faux Battery. Shown herein is a mock or faux battery within the actual battery cavity and is made of epoxy, hard plastic, soft plastic, metal, etc., 304, 305. With a closed connection, a metal snap connector is connected to the instrument's snap connector closing the connection allowing the ground on the jack to become the power source from the Transfer Station 303. The distance between the middle of input and output jacks 301, 308 is 13.0 mm. The bottom of the faux battery is 306 and the top is 307; the distance between 306 and 307 is 44.7 mm, whereas the distance between the top of the input/output jacks 308 and bottom 306 is 48.8 mm. The upper cross-section is 310, 312, and the distance between 310, 312 is 311 and is 16.9 mm.

It is to be understood that the above description is intended to be illustrative and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claims.

We claim:

1. An electrical device for musical instruments comprising a hollow transfer station with an inner chamber, the chamber further comprising a combination of at least one audio signal cable and at least one power cable within the station, and is configured to eliminate batteries.

2. The device of claim 1, wherein the audio cable comprises mono input jacks for the audio signal's output.

3. The device of claim 2, wherein the mono input jack is connected to the mono-cable, and the jack is attached to the transfer station's wall.

4. The device of claim 1, wherein the audio cable comprises stereo input jacks for the audio signal's output.

5. The device of claim 4, wherein the stereo input jack is connected to the stereo cable, and the jack is attached to the transfer station's wall.

6. The device of claim 1, wherein the audio signal cable is configured in audio signal processing applications.

7. The device of claim 1, wherein the power cable(s) total electrical potential is equivalent to the battery's electrical potential.

8. The device of claim 7, wherein the power cable can have a total electrical potential of 1 to 22 volts.

9. The device of claim 1, wherein the transfer station comprises two DC power connectors for the AC/DC external supply.

10. The device of claim 1, wherein the transfer station comprises at least one quarter inch stereo input jack for the audio signal.

11. The device of claim 1, wherein the transfer station comprises at least one quarter inch mono input jack for the audio signal.

12. The device of claim 1, wherein the transfer station comprises a quarter-inch stereo input jack that doubles as the input for the musical instrument signal and the output for a power source.

13. The device of claim 1, wherein the transfer station comprises one or more from a group consisting of XLR, XLR combo jack, eight-inch jacks, phone jacks, TRRS, Tip-Ring-Ring-Sleeve jacks, and any combination thereof.

14. The device of claim 1, wherein the transfer station comprises aluminum, wherein the station dimensions are length 3.94 inches×width 1.97 inches×depth 1.06 inches.

15. The device of claim 1, wherein the transfer station can power at least one stompboxes.

16. The device of claim 15, wherein the stompboxes can require a total electrical potential of 1 to 22 volts.

17. The device of claim 1, wherein the electrical device for musical instruments, comprises a mock nine-volt battery adapter, wherein the mock battery is placed within the battery cavity.

18. The device of claim 17, wherein the mock battery adapter comprises an epoxy.

19. The device of claim 17, wherein the mock battery adapter comprises a plastic

20. The device of claim 17, wherein the mock battery adapter comprises a closed connection metal first snap connector, and the first nap connector is connected to the second snap connector of the musical instrument closing the connection allowing the ground on the jack to become the power source from the Transfer Station.
